(19) United States
(12) Patent Application Publication
(10) Pub. No.: US 2026/0246668 A1
(43) Pub. Date: Aug. 20, 2026

(54) RESNETU-BASED WIRELESS CHANNEL ESTIMATION

(71) Applicant: Samsung Electronics Co., Ltd., Suwon-si (KR)

(72) Inventors: Guanbo Chen, Hillsborough, NJ (US); Xiaochuan Ma, Hillsborough, NJ (US); Daoud Burghal, San Jose, CA (US); Yan Xin, Princeton, NJ (US); Jianzhong Zhang, Dallas, TX (US)

(21) Appl. No.: 19/461,543

(22) Filed: Jan. 27, 2026

Related U.S. Application Data
(60) Provisional application No. 63/758,914, filed on Feb. 14, 2025.

(51) Int. Cl. H04L 25/02; H04L 1/00; H04L 5/00

(52) U.S. Cl. CPC H04L 25/0254; H04L 1/0008; H04L 1/0064; H04L 5/0044; H04L 25/0224

(57) ABSTRACT

A method for channel estimation includes receiving, by a first electronic device, an uplink signal from a second electronic device over a channel, the uplink signal including demodulation references signals (DMRS); preprocessing, by the first electronic device, the received uplink signal to generate a noisy channel image including a real part and an imaginary part derived from each DMRS; and performing, by the first electronic device, channel estimation based on the noisy channel image using an artificial intelligence (AI) model trained to denoise an input channel image, the AI model having a residual network U-shaped (ResnetU) structure including downsamplers and upsamplers configured for physical uplink shared channel (PUSCH) channel estimation.

### CROSS-REFERENCE TO RELATED APPLICATION AND CLAIM OF PRIORITY

The present application claims priority under 35 U.S.C. § 119 (e) to U.S. Provisional Patent Application No. 63/758,914 filed on Feb. 14, 2025, which is hereby incorporated by reference in its entirety.

### TECHNICAL FIELD

This disclosure relates generally to wireless networks. More specifically, this disclosure relates to a method and apparatus for channel estimation using a residual network U (ResnetU).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for ResnetU-based channel estimation in wireless communication systems.

In one embodiment, a method for channel estimation is provided. The method includes receiving, by a first electronic device, an uplink signal from a second electronic device over a channel, the uplink signal including demodulation references signals (DMRS); preprocessing, by the first electronic device, the received uplink signal to generate a noisy channel image including a real part and an imaginary part derived from each DMRS; and performing, by the first electronic device, channel estimation based on the noisy channel image using an artificial intelligence (AI) model trained to denoise an input channel image, the AI model having a residual network U-shaped (ResnetU) structure including downsamplers and upsamplers configured for physical uplink shared channel (PUSCH) channel estimation.

In another embodiment, a first electronic device is provided. The first electronic device includes a memory and a processor operably coupled to the memory. The processor is configured to: receive an uplink signal from a second electronic device over a channel, the uplink signal including DMRS; preprocess the received uplink signal to generate a noisy channel image including a real part and an imaginary part derived from each DMRS; and perform channel estimation based on the noisy channel image using an AI model trained to denoise an input channel image, the AI model having a ResnetU structure including downsamplers and upsamplers configured for PUSCH channel estimation.

In yet another embodiment, a non-transitory computer readable medium embodying a computer program is provided. The computer program includes program code that, when executed by a processor of a first electronic device, causes the first electronic device to: receive an uplink signal from a second electronic device over a channel, the uplink signal including DMRS; preprocess the received uplink signal to generate a noisy channel image including a real part and an imaginary part derived from each DMRS; and perform channel estimation based on the noisy channel image using an AI model trained to denoise an input channel image, the AI model having a ResnetU structure including downsamplers and upsamplers configured for PUSCH channel estimation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example network device in accordance with example embodiments of the present disclosure;

FIG. 5 illustrates an example pipeline for a ResnetU-based CE method in accordance with example embodiments of the present disclosure;

FIG. 6 illustrates an example architecture of a ResnetU-based CE model in accordance with example embodiments of the present disclosure;

FIG. 7 illustrates an example upsampled image in accordance with the example embodiments of the present disclosure;

FIG. 8 illustrates an example upsampled image in accordance with the example embodiments of the present disclosure;

FIG. 9 illustrates an example architecture of an enhanced Resnet block in accordance with example embodiments of the present disclosure;

FIG. 10 illustrates an example edge error effect of some AI CE models;

FIG. 11 illustrates an example symbol patching mechanism in accordance with example embodiments of the present disclosure;

FIG. 12 illustrates an example process of the symbol patching mechanism in accordance with example embodiments of the present disclosure;

FIG. 13 illustrates an example hybrid frequency-delay domain CE technique in accordance with example embodiments of the present disclosure;

FIG. 14 illustrates example graphs depicting the hybrid frequency-delay domain CE technique of FIG. 13 in accordance with example embodiments of the present disclosure;

FIG. 15A illustrates an example process of a delay domain CE technique using a fixed sized RB in accordance example embodiments of the present disclosure;

FIG. 15B illustrates an example performance of the example process of FIG. 15A in accordance with example embodiments of the present disclosure;

FIG. 16 illustrates an example hybrid frequency-delay domain CE technique in accordance with example embodiments of the present disclosure; and

FIG. 17 illustrates a flow chart for a ResnetU-based CE method according to embodiments of the present disclosure.

### DETAILED DESCRIPTION

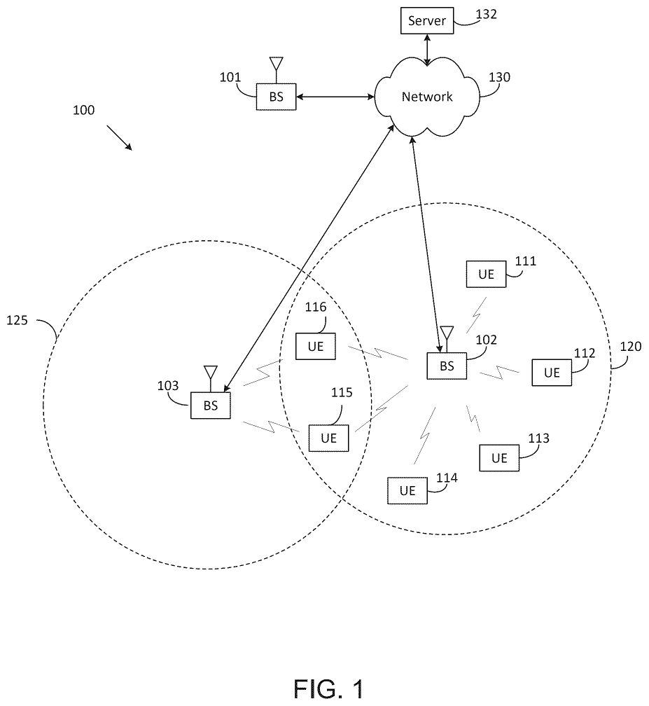

FIGS. 1 through 17, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of ResnetU-based channel estimation techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 via backhaul/network interfaces and train an AI model to perform channel estimation. The server 132 may represent one or more servers, and each server 132 includes a suitable computing or processing device for training the AI/ML model. Each server 132 could, for example, include one or more processing devices, one or more memories storing instructions and data, and one or more network interfaces to receive the data. The AI model is then trained and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support AI-based channel estimation in wireless communication systems. In certain embodiments, one or more of the gNBs 101-103 include circuitry, programing, or a combination thereof, to utilize data preparation for AI/ML model training in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

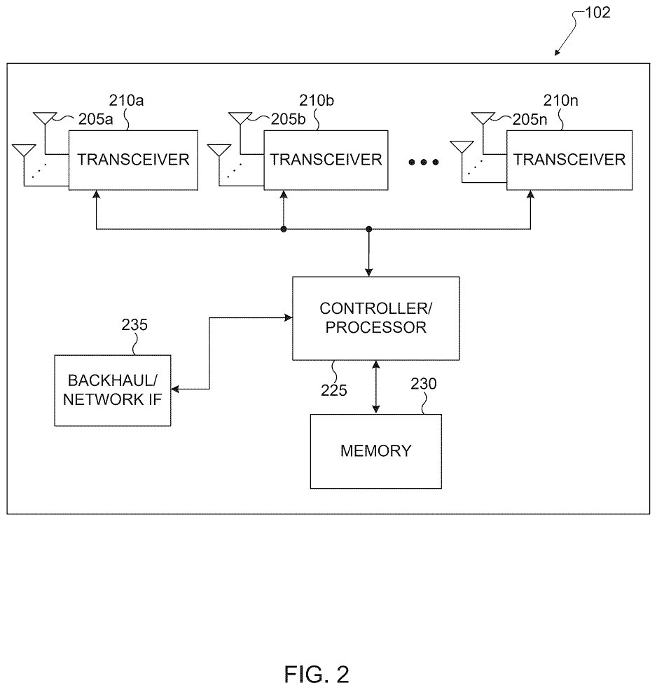

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform NAFNet-based channel estimation in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

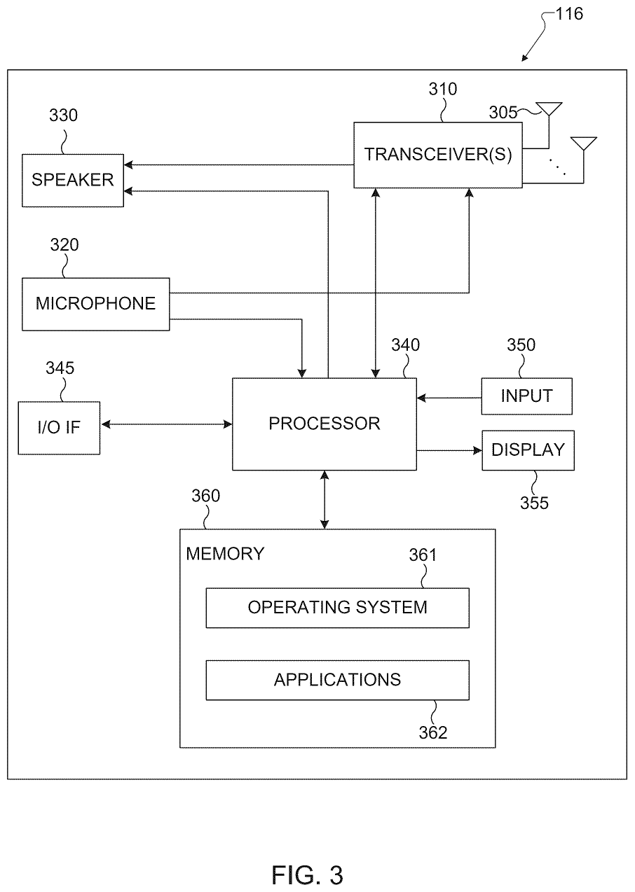

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support ResnetU-based channel estimation in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

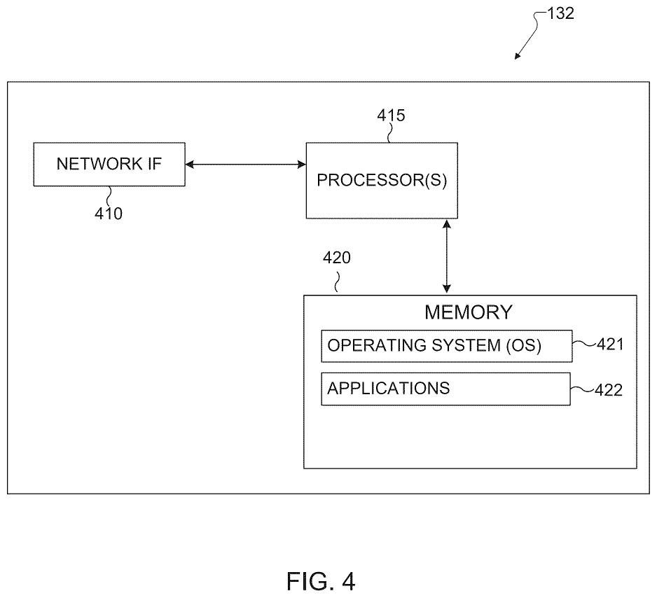

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources required for training the neural network.

The processor 415 is also capable of executing other processes and programs resident in the memory 420, such as operations that receive and store data. As described in greater detail below, the processor 415 may execute processes to train an AI model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

In modern wireless systems, such as those described regarding FIGS. 1-4, channel estimation is a fundamental and critical process that plays a pivotal role in ensuring the reliable transmission of data between transmitters and receivers. Wireless communication systems, however, may be inherently susceptible to various impairments and variations in the radio propagation environment, leading to fluctuations in the channel characteristics. Channel estimation may mitigate the adverse effects of these variations by providing accurate information about the current state of the communication channel.

A wireless channel may be a dynamic medium through which signals transmit, and can be affected by factors such as multi-path fading, interference, noise, and mobility. Channel estimation may provide a critical means to track and adapt to these dynamic changes, allowing the wireless communication system to optimize its performance. In essence, channel estimation may involve estimating channel parameters (such as amplitude, phase and delay), which may be then utilized by the receiver to demodulate and decode transmitted signals accurately.

Some channel estimation methods may rely on pilot signals, which are known symbols inserted into the transmitted signal, allowing the receiver to measure the channel response at specific points in time. These measurements may then be used to interpolate the channel characteristics between the pilot symbols, thus providing an estimate(s) of the channel conditions. However, the channel estimation solutions such as least square (LS) and linear minimum mean square error (LMMSE) may fail to achieve the desirable estimation accuracy with a reasonable complexity, particularly in the low signal-to-noise ratio (SNR) regime.

In recent years, the integration of machine learning techniques into channel estimation processes has gained a substantial attention and shown a great promise in improving the accuracy and efficiency of channel estimation. Machine learning-based channel estimation may leverage the power of AI and data-driven approaches to adapt and learn from the behavior(s) of the wireless channel, making it more robust to varying conditions and potentially reducing the need for explicit pilot signals.

Examples of machine learning-based channel estimation methods may include:
1. Deep Learning Approaches: Deep neural networks, including convolutional neural networks (CNNs), recurrent neural networks (RNNs) and transformer architectures, have been applied to channel estimation tasks. These networks can learn complex relationships between received signals and the channel characteristics, allowing for accurate and efficient estimation.
2. Reinforcement Learning: Reinforcement learning techniques can be used to optimize the transmission and reception strategies in response to changing channel conditions, effectively improving channel estimation and overall system performance.
3. Autoencoders: Autoencoders are neural network architectures that can be used for unsupervised learning of channel representations. They can capture channel characteristics and reduce the reliance on pilot signals.
4. Transfer Learning: Transfer learning techniques enable the adaptation of pre-trained models to specific channel environments, enhancing the generalization of channel estimation algorithms across different scenarios.
5. Diffusion model: Diffusion model includes the denoising diffusion probabilistic models (DDPM) and score matching with Langevin dynamics (SMLD). In particular, a framework for training score-based generative models for MIMO channel estimation has been introduced. Based on the SMLD algorithm, the channel estimation solution in this framework may first learn the score function of the channel data using denoising score matching, obtain the close-form score function of the likelihood, and finally complete the posterior sampling process following the annealed Langevin dynamics.

Machine learning-based channel estimation methods may potentially render the wireless communication systems more adaptive, efficient, and robust, particularly in challenging environments. As the field of machine learning continues to advance, these methods may play an increasingly important role in optimizing the wireless communication systems for a wide range of applications, including 5G, IoT, and beyond.

This disclosure provides approaches for estimating the channel state information with a customized ResnetU deep learning model. In these ResnetU-based channel estimation (CE) methods, a ResnetU architecture may utilize a unique downsampling and upsampling strategy designed specifically for a PUSCH channel estimation problem, which can significantly reduce the computation complexity of other Resnet architectures while boosting the PUSCH CE performance. Moreover, the ResnetU architecture may utilize a unique training data arrangement approach that combines two DMRS symbols at the edge to reduce the edge effect of CE problems. Further, the ResnetU-based CE methods in accordance with the present disclosure may perform CE in the delay domain using a basic processing block to significantly reduce the computation complexity for large resource block cases while retaining similar channel estimation performance.

Accordingly, by customizing PUSCH CE downsampling and upsampling in a ResnetU architecture, the ResnetU-based CE methods in accordance with the present disclosure may decrease computation complexity and increase model capacity and the PUSCH CE performance. By providing training data patching based on combining multiple DMRS symbols from different time slots at one or more edges of the multiple DMRS symbols, the ResnetU-based CE methods may reduce one or more edge effects prone to occur during PUSCH CE. By providing hybrid frequency-delay domain ResnetU-based CE techniques, the embodiments of the present disclosure may significantly decrease computation costs for large resource block (RB) cases while maintaining the CE performance.

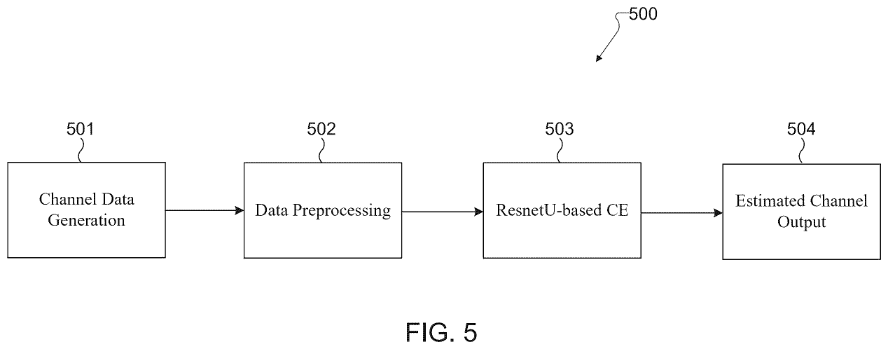

FIGS. 5-17 illustrate non-limiting embodiments of the ResnetU-based CE method, the resultant benefits, and related concepts thereof in greater detail in accordance with the present disclosure.

FIG. 5 illustrates an example pipeline 500 for a ResnetU-based CE method in accordance with example embodiments of the present disclosure. The example pipeline as shown in FIG. 5 is for illustration only, and could have the same or similar configuration. One or more of the components illustrated in FIG. 5 may be implemented in specialized circuitry configured to perform the noted functions or one or more of the components may be implemented by one or more processors executing instructions to perform the noted functions. Other embodiments of the pipeline for the ResnetU-based CE (also referred to as ResnetU CE) method in accordance with the present disclosure could be used without departing from the scope of this disclosure. FIG. 5 does not limit the scope of this disclosure to any particular embodiment of the ResnetU-based CE pipelines.

As previously mentioned, channel estimation is a process of estimating the wireless communication channel parameters or characteristics, such as its frequency response, delay spread, and fading coefficients. Hence, channel estimation is important for coherent detection and decoding of the transmitted signals, as well as for optimization of the transmission parameters, such as power allocation, modulation scheme, and coding rate. As such, channel estimation can improve the accuracy and reliability of the received signals, and increase the capacity and performance of wireless communication systems.

However, channel estimation can be particularly challenging, especially for high-dimensional signals in systems involving multiple antennas, multiple subcarriers and multiple users. The channel estimation problem can be formulated as finding the solution that best satisfies a system of equations relating the transmitted signals, received signals, channel coefficients and noise. The complexity and difficulty of this problem may depend on the number and arrangement of the channel of the channel coefficients, the availability and quality of the pilot signals, the noise level and distribution, and the channel dynamics and variations. Various methods and techniques have been proposed to tackle this problem, such as linear interpolation, least squares, minimum mean square error, maximum likelihood, Bayesian interference, and deep learning.

The example embodiments in the present disclosure may solve the channel estimation problem in the following form. In the frequency domain, the input-output relationship at pilot tones (subcarriers) between the transmitted and received signals can be expressed as:

$$Y = H ⊙ X + N \qquad EQ . ( 1 )$$

Here, Y∈ [symbol] ^{N}^{_{fp}}^{×N}^{_{fn}} are the received signals at pilot tones. H∈ [symbol] ^{N}^{_{fp}}^{×N}^{_{fn}} is the channel matrix, and ⊙ represents the Hadamard product that is an element-wise product. X∈ [symbol] ^{N}^{_{fp}}^{×N}^{_{fn}} are the transmitted pilot signals known to the receiver, and N∈ [symbol] ^{N}^{_{fp}}^{×N}^{_{fn}} is an additive white Gaussian noise (AWGN).

In particular, the mathematical model described in EQ. (1) may be applicable to different types of signal models (e.g., without limitation, single input single output (SISO), single input multiple output (SIMO), and MIMO cases). For example, in a SIMO signal model, N_{fp} and N_{fn} can be used to represent the number of the pilot tones (subcarriers) in the frequency domain over one OFDM symbol and the number of the received antennas, respectively. On the other hand, in a SISO case, N_{fp} and N_{fn} can be used to represent the number of the pilot tones (subcarriers) in the frequency domain over one OFDM symbol and the number of the OFDM symbols containing pilot tones, respectively. Note that MIMO signal models can be readily converted to a SIMO case where pilot signals from different transmitted antennas are separated in time, frequency, or code domains.

The goal of the channel estimation task may be to estimate H based on pilot signals X and received signals Y. Without loss of generality, pilot signals X may be assumed as an identity matrix, and thus the signal model in EQ. (1) can be rewritten as:

$$\tilde{H} = H + N . \qquad EQ . ( 2 )$$

Note that the embodiments of this disclosure can be readily applied to cases in which pilot signals X are not an identity matrix.

Referring back to FIG. 5, the pipeline for the ResnetU-based CE method in accordance with the present disclosure may include four operations: channel data generation operation 501, data preprocessing operation 502, ResnetU-based CE operation 503, and estimated channel output operation 504.

The channel data generation operation 501 may refer to a process to obtain the channel response data or received signal data. In this operation, not only the data but also some extra information about the channel or received signals, e.g., signal to noise ratio (SNR) or transmission power may also be estimated and stored. This operation can be performed by channel simulation based on wireless channel models or the measurement carried out in the real field. This data may be utilized to train and test a ResnetU-based CE model.

The data preprocessing operation 502 may be performed on the generated raw channel data so that the channel data may have a better structure and render the model learning easier. The input to the ResnetU CE model may be designed as Batch×H×W×C. The H×W×C may represent an image with H height, W width and C number of channels. The Batch may represent the number of images to be processed by the ResnetU CE model at one time. For a PUSCH CE problem, the input signals may be mapped to H×W×C dimensions. If there is one DMRS symbol, then C may include two elements: the real and imaginary parts of the DMRS symbol. If there are two DMRS symbols, then C may include four elements: the real and imaginary parts of DMRS symbol 1 and the real and imaginary parts of DMRS symbol 2. These four elements can be stacked as (Real (DMRS1), Imag (DMRS1), Real (DMRS2), Imag (DMRS2)), or (Real (DMRS1), Real (DMRS2), Imag (DMRS1), Imag (DMRS2)). The H×W can be subcarriers X antennas or antennas X subcarriers, where the subcarriers are the pilot tones of an OFDM symbol and the antennas refer to the number of antennas at the base station. The original raw channel data may be transformed into the format of Batch×H×W×C to be processed by the ResnetU CE model. Hereinafter, it may be assumed that H may be the antenna dimension and W may be the subcarrier dimension. PUSCH may have six subcarriers in every resource block. Sampling in accordance with the present disclosure may be customized by a factor of 2 and then 3 to ensure there may be no padding at the bottom 605 of the network.

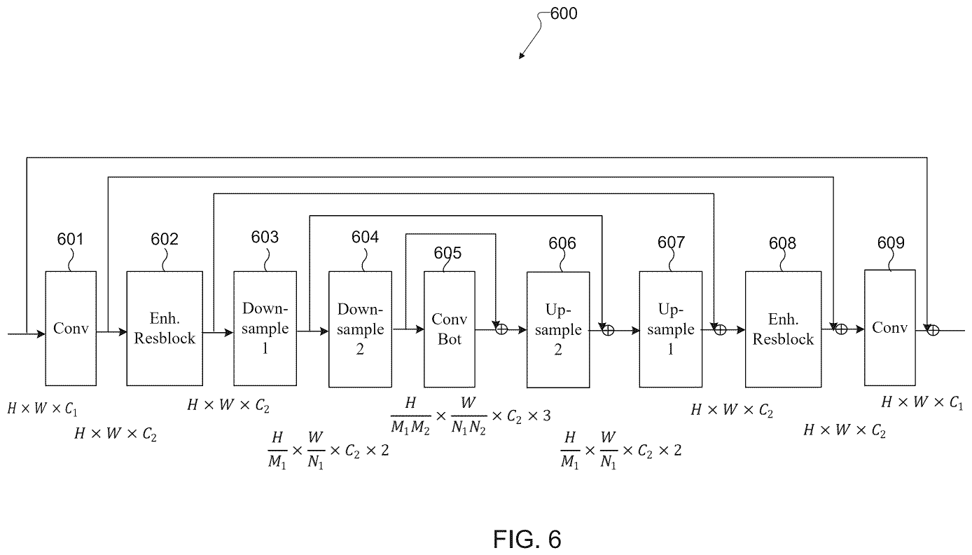

The ResnetU-based CE operation 503 may be performed by a ResnetU-based CE model, which may be built and trained with the preprocessed data set. The ResnetU-based CE model may be trained to receive a noisy channel response as an input and perform channel estimation based on the noisy channel response. The trained ResnetU CE model may be applied to perform channel estimation. The ResnetU-based CE model is discussed further in detail with reference to FIG. 6.

The estimated channel output operation 504 may include the ResnetU-based CE model outputting the estimated channel response.

FIG. 6 illustrates an example architecture of a ResnetU-based CE model 600 in accordance with example embodiments of the present disclosure. The example architecture as shown in FIG. 6 is for illustration only, and the architecture could have the same or similar configuration. One or more of the components illustrated in FIG. 6 may be implemented in specialized circuitry configured to perform the noted functions or one or more of the components may be implemented by one or more processors executing instructions to perform the noted functions. Other embodiments of the architecture of a ResnetU-based CE model in accordance with the present disclosure could be used without departing from the scope of this disclosure. FIG. 6 does not limit the scope of this disclosure to any particular embodiment of ResnetU-based CE model architectures.

As shown in FIG. 6, the ResnetU-based CE model 600 may include an initial convolutional block 601, an enhanced Resnet block (Resblock) 602, a first downsampler 603, a second downsampler 604, a convolutional bottom (bottleneck) layer 605, a first upsampler 606, a second upsampler 607, a second enhancement Resblock 608, and a final convolutional block 609.

The initial convolutional block 601, the convolutional bottleneck layer 605 and the final convolutional block 609 may perform the same size convolution, and thus padding may be applied to ensure that the input and output images after convolution are of the same size.

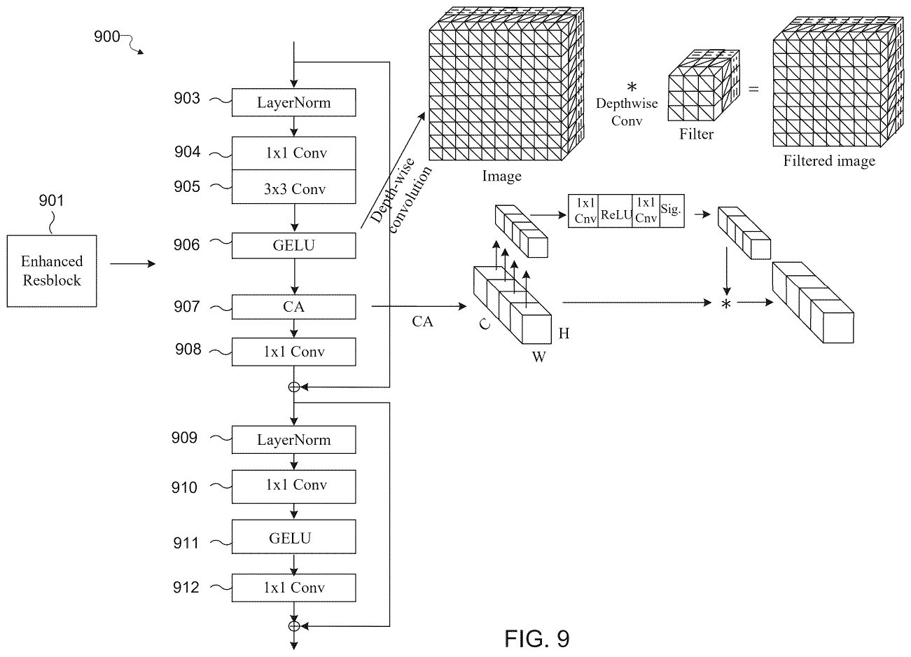

The enhanced Resblocks 602 and 608 may perform further refinement of the extracted features maps and upsampled images, respectively, as illustrated in FIG. 9.

The parameters of the ResnetU-based CE model 600 may include H, W, and C as shown in FIG. 6. Table 1 below provides exemplary values for these parameters.

TABLE 1
Example parameter values for ResnetU CE model

| Parameter | Value | Use |
|---|---|---|
| Channel number C₁ | 4 | Symbol, Real/Imaginary |
| Channel number C₂ | 6 | Embedded features |
| H sample factor M₁ | 2 | Antenna |
| W sample factor N₁ | 2 | Subcarrier |
| H sample factor M₂ | 2 | Antenna |
| W sample factor N₂ | 3 | Subcarrier |

One of the significant aspects of the ResnetU-based CE model 600 may be the downsampling strategy utilized in the downsamplers 603, 604. These downsamplers 603, 604 may be configured to shrink the size of the input image in H×W dimension while boosting the number of channels in C dimension. Note that the number of channels C represents how many feature maps a neural network may learn. For example, for image classification tasks, different channels can represent an object's shape, edge, texture, etc. Thus, boosting the number of channels may allow the neural network to learn more features of the wireless channel image. Further, more channels C may result in more parameters of the neural network, thereby increasing the network capacity and learning.

In PUSCH, the number of RB used for each transmission can be different. To be able to control the final image size after downsampling that may be utilized for pixelshuffle based up-sampling, the product of the downsampling factors N₁, N₂ in the subcarrier domain may be designed to match the total number of subcarriers per RB in PUSCH. For example, if the number of subcarriers per RB is 6, then the downsampling factors can be selected as, e.g., N₁=2, N₂=3, or N₁=3, N₂=2 because N₁×N₂=6. Hence, regardless of the number of RBs used for transmission, the downsampled image size in subcarrier dimension may always equal N_{RB}, which is the total number of RB used. Thus, the constraint to choose N₁, N₂ may be N₁×N₂=N_{subcarrierPerRB}. In the antenna dimension, as the antenna number may be predetermined and not change, the choice of M₁ and M₂ may only satisfy that M₁×M₂ equals a factor of Nₐₙₜ. For example, if there are 16 antennas (Nₐₙₜ=16), M₁ can be 2 and M₂ can be 2 because M₁×M₂ is a factor of Nₐₙₜ. The downsampling 603 and 404 may be achieved by performing stride convolution with the stride number equal the downsampling factors. Note that the size control may be utilized since the upsampled final image is to have the same size as the input image to the neural network and the exact size of the daownsampled image may be calculated and known prior to downsampling. Thus, the pixelshuffle based upsampling can be designed to have the same output image size as the input.

In addition, the kernel size of the convolutional filters and padding size of the image may also be adjusted to ensure that the image size is reduced by a desired factor after downsampling. The present disclosure provides an approach to compute the closest kernel size and the corresponding padding size to achieve this goal. If the original kernel size of the convolution filter equals Kₒᵣᵢ and the downsampling factor equals N, then the adjusted kernel size K_{adj} and the padding size N_{pad} can be calculated as follows:

$${K}_{adj} = ceil ( \frac{{K}_{ori} - N}{2} ) * 2 + N$$

$${N}_{pad} = floor ( \frac{{K}_{adj} - N}{2} )$$

Here, ceil( ) is the function to find the smallest integer number larger than the input number, and floor( ) is the function to find the largest integer number smaller than the input number. For example, assume that the original image has the size of (12*6,16), the original filter kernel size is (5,5), and the downsampling factors are (3,2). Then, the adjusted filter kernel size may be (5,6), and the padding size may be (1,2), where both sides of H are padded with 1 pixel and both sides of W are padded with 2 pixels. With this design, the final reduced image size after convolution based downsampling may be (24,8), which is a factor (3,2) times smaller than the original image size (72,16).

The present disclosure also provides a ResnetU-based CE model design, which may include the upsamplers 606 and 607 for performing nonuniform pixelshuffle based upsampling. In some pixelshuffle upsampling techniques (e.g., implemented in a pytorch library), the H and W dimensions of the image may need to be upscaled by the same factor. In some ResnetU models, the image may be ubsampled nonuniformly in H and W dimensions. Thus, a nonuniform upsampling method with pixelshuffle may be needed. The nonuniform pixelshuffle in accordance with the present disclosure may include the following three steps:
1. Assume the batch images in the bottom layer (605) have the dimension of (B, C, H, W). The upscaling factors for H and W dimension are M and N. Then, the images may be reshaped from (B, C, H, W) to (B,

$$\frac{C}{MN} ,$$

### M, N, H, W).

2. In order to perform upsampling correctly, one key step may be to reorganize the data. The images may be permuted from (B,

$$\frac{C}{MN} ,$$

### M, N, H, W) to (B,

$$\frac{C}{MN} ,$$

### H, M, W, N)

3. In the final step, the images may be reshaped from (B,

$$\frac{C}{MN} ,$$

### H, M, W, N) to (B,

$$\frac{C}{MN} ,$$

### H×M,W×N).

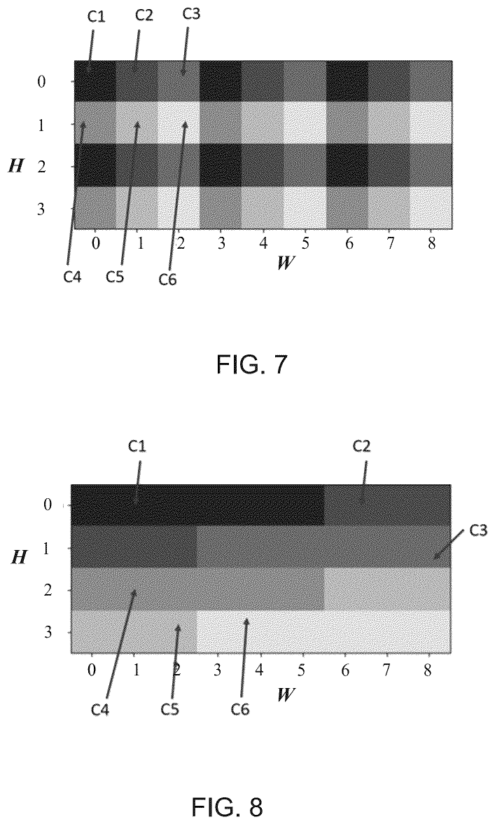

FIGS. 7 and 8 illustrate example upsampled images 700, 800 in accordance with the example embodiments of the present disclosure. The example upsampled images as shown in FIGS. 7 and 8 are for illustration only, and thus different upsampled images may be generated using the ResnetU-based CE model without departing from the scope of the present disclosure.

Where an image has a size of (B, C, H, W)=(1,6,2,3), it may be upsampled by a factor of 2 and 3 in H and W dimensions with pixelshuffle. As shown in FIG. 7, the pixels of the upsampled image may be arranged such that C1, C2, C3, C4, C5 and C6 represent the 6 original channels to which each pixel belongs. As can be seen in FIG. 7, the pixels from the original 6 channels are very well interleaved. In contrast, if Step 2 from the nonuniform pixelshuffle based unsampling method is removed, the upsampled image may include non-interleaved pixels as shown in FIG. 8.

As can be seen in FIG. 8, without Step 2, the pixels from different channels may be no longer interleaved and the spatial information from the same region across different channels may be separated far away in the upsampled image. Thus, the nonuniform pixelshuffle based upsampling technique may allow for a meaningful and effective pixelshuffle based upsampling when the two dimensions in the image are not the same (nonuniform), thereby providing significant improvements over the machine learning tools via which the pixelshuffle upsampling can only be done when the two dimensions of the image are the same.

FIG. 9 illustrates an example architecture 900 of an enhanced Resnet block (also referred to herein as an enhanced Resblock) 901 in accordance with example embodiments of the present disclosure. The example architecture as shown in FIG. 9 is for illustration only, and the architecture could have the same or similar configuration. One or more of the components illustrated in FIG. 9 may be implemented in specialized circuitry configured to perform the noted functions or one or more of the components may be implemented by one or more processors executing instructions to perform the noted functions. Other embodiments of the architecture of an enhanced Resblock in accordance with the present disclosure could be used without departing from the scope of this disclosure. FIG. 9 does not limit the scope of this disclosure to any particular embodiment of an enhanced Resblock architectures.

The enhanced Resblock 901 may start with a layer normalization (also referred to herein as a layernorm) 903. Next, a 1×1 convolution filter 904 may be utilized, followed by a 3×3 depth-wise convolution layer 905, which may filter the image with a minimal computation cost. Next, an activation function (e.g., a GELU activation function) 906 may be utilized, and channel attention (CA) 907 may be performed to scale each channel's data by the pooled information from the spatial dimension.

After the CA 907, a 1×1 convolution 908 may be attached where a skip connection is utilized to add the original input image to the output.

Next, a series of a layernorm 909, a 1×1 convolution 910, an activation function (e.g., a GELU activation function) 911 and another 1×1 convolution 912 may be utilized with another skip connection as shown in FIG. 9.

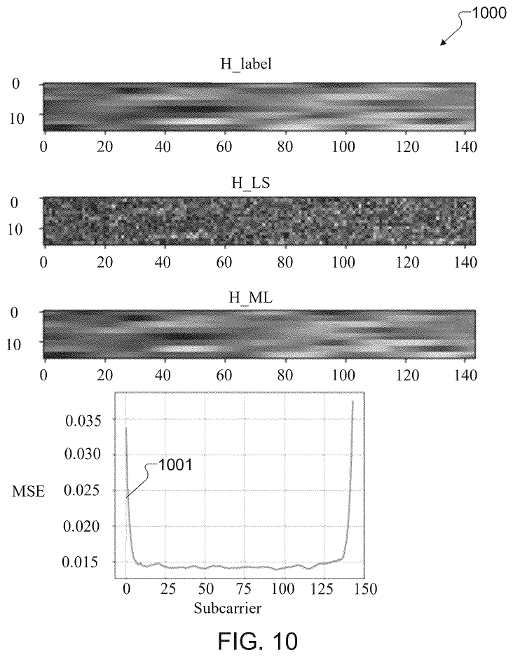

FIG. 10 illustrates an example edge error effect 1000 of some AI CE models. The example edge error effect as shown in FIG. 10 is for illustration only, and may differ depending on the types of the AI CE models being utilized.

For PUSCH CE, the AI model denoised image at the edge may show larger errors than the pixel in the middle of the image. As can be seen in FIG. 10, there may be a ground truth channel image H_label, and a noisy channel image H_LS and the AI model filtered channel image H_ML.

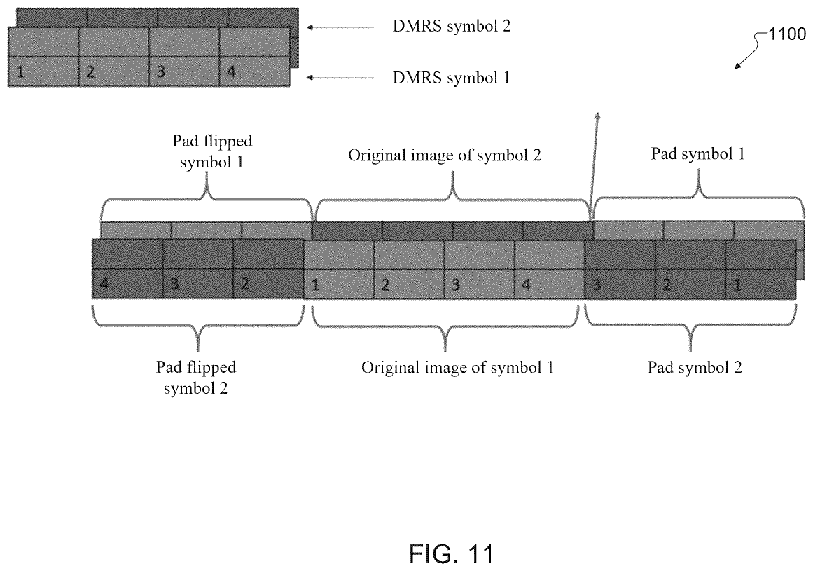

Comparing H_label with H_ML, it can be found that the mean square error 1001 may be larger at the edge. This may be due to lack of the spatial information outside of the image domain when the convolution filters of the AI model are filtering the edge pixels. To alleviate the edge error problem in the AI model filtered channel image, the present disclosure provides example symbol patching mechanisms as illustrated in FIG. 11.

FIG. 11 illustrates an example symbol patching mechanism 1100 in accordance with example embodiments of the present disclosure. The example mechanism as shown in FIG. 11 is for illustration only, and the mechanism could have the same or similar configuration. One or more of the components illustrated in FIG. 11 may be implemented in specialized circuitry configured to perform the noted functions or one or more of the components may be implemented by one or more processors executing instructions to perform the noted functions. Other embodiments of the symbol patching mechanism in accordance with the present disclosure could be used without departing from the scope of this disclosure. FIG. 11 does not limit the scope of this disclosure to any particular embodiment of symbol patching mechanisms.

In order to alleviate the edge error problem in the AI model filtered channel image, two DMRS symbols (DMRS symbol 1 and DMRS symbol 2) transmitted in PUSCH may be utilized. The numbers 1, 2, 3, and 4 within the DMRS symbols represent the subcarrier indices.

As the two DMRS symbols may be only transmitted with a very short interval apart, the channel images may be mostly similar while the channel noises can be random and different. Thus, the DMRS symbol 2 may be concatenated to the edge of DMRS symbol 1, and DMRS symbol 1 may be concatenated to the edge of DMRS symbol 2 during the AI model based channel image denoising. As shown in FIG. 11, flipped DMRS symbols may be padded to the left of the original image to ensure the close subcarriers with a higher correlation may be patched together.

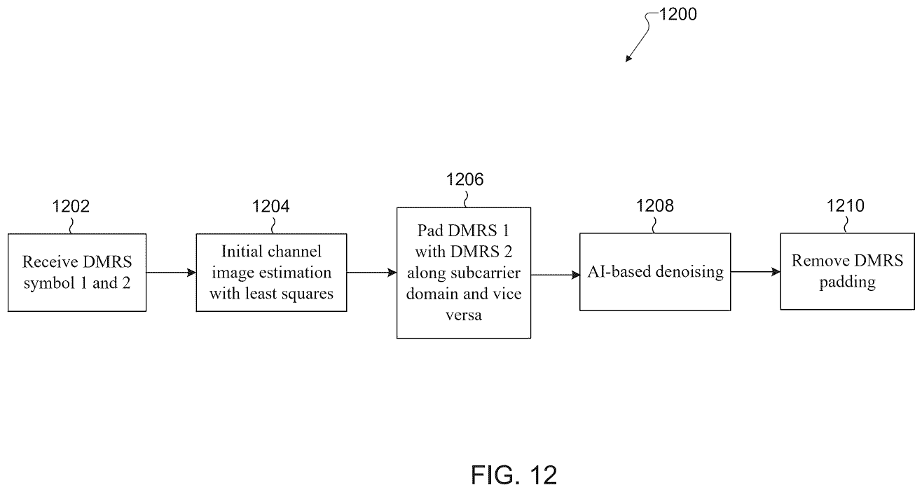

Since the clean image pattern of the two DMRS symbols may be correlated while the noise of the two DMRS symbols may remain uncorrelated, the padded DMRS symbols at the edge can help each other to fill in or make up the missing spatial information at the edge without introducing correlated noise into the image. The detailed steps of the patching mechanism is discussed further in detail with reference to FIG. 12.

FIG. 12 illustrates an example process 1200 of the symbol patching mechanism in accordance with example embodiments of the present disclosure. The symbol patching mechanism may be similar to the symbol patching mechanism 1100 of FIG. 11. The example process shown in FIG. 12 is for illustration only, and the process could have the same or similar configuration. One or more of the components illustrated in FIG. 12 may be implemented in specialized circuitry configured to perform the noted functions or one or more of the components may be implemented by one or more processors (e.g., the processor 225 or 415 in FIG. 2 or 4) executing instructions to perform the noted functions. Other embodiments of the symbol patching mechanism in accordance with the present disclosure could be used without departing from the scope of this disclosure. FIG. 12 does not limit the scope of this disclosure to any particular embodiment of symbol patching mechanisms.

In the example of FIG. 12, the process 1200 begins at step 1202. At step 1202, an AI model (e.g., a ResnetU-based CE model) may receive a first DMRS symbol and a second DMRS symbol. At step 1204, the AI model may obtain an initial channel image estimate of an input channel image using an optimization technique (e.g., least squares).

At step 1206, the first DMRS symbol in a subcarrier dimension may be flipped and the flipped first DMRS symbol may be concatenated to the edges of the second DMRS symbol. The second DMRS symbol may be padded with the flipped first DMRS symbol along the subcarrier dimension. The second DMRS symbol in the subcarrier dimension may also be flipped and the flipped second DMRS symbol may be concatenated to the edges of the first DMRS symbol. The first DMRS symbol may then be padded with the flipped second DMRS symbol along the subcarrier dimension.

At step 1208, the AI model may denoise the input channel image. At step 1210, padded flipped first and second DMRS symbols may be removed.

Thus, the present disclosure provides an approach of combining multiple DMRS symbols at the edges in the AI-model training data in order to reduce edge effect in the AI-based PUSCH CE. By providing training data patching based on combining multiple DMRS symbols from different time slots at one or more edges of the multiple DMRS symbols, the one or more edge effects for PUSCH CE can be reduced significantly.

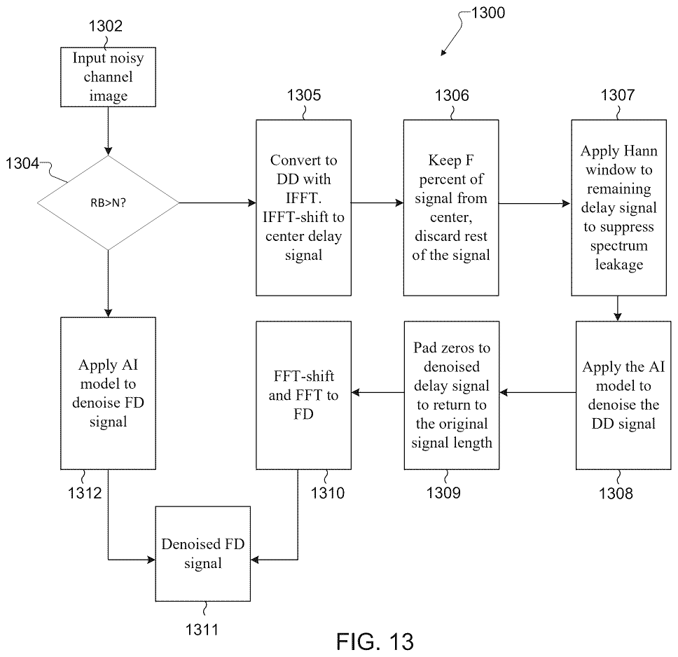

FIG. 13 illustrates an example hybrid frequency-delay domain CE technique 1300 in accordance with example embodiments of the present disclosure. The example technique shown in FIG. 13 is for illustration only, and the technique could have the same or similar configuration. One or more of the components illustrated in FIG. 13 may be implemented in specialized circuitry configured to perform the noted functions or one or more of the components may be implemented by one or more processors (e.g., the processor 225 or 415 in FIG. 2 or 4) executing instructions to perform the noted functions. Other embodiments of the hybrid frequency-delay domain CE technique in accordance with the present disclosure could be used without departing from the scope of this disclosure. FIG. 13 does not limit the scope of this disclosure to any particular embodiment of hybrid frequency-delay domain CE techniques.

In order to reduce the computation cost, the fact that the channel image is sparse in the delay domain may be utilized. Hence, AI denoising may be performed only on a part of the delay domain image to reduce the overall computation cost. However, this approach may result in a slight channel denoising performance. Therefore, the delay domain denoising may be only applied to the cases when the size of RB is larger than a certain threshold. This is because when the RB number is small, the computation cost may not be high such that PUSCH CE can still be processed in real time. However, when the RB number is large, without the delay domain technique in accordance with the present disclosure, the computation cost of PUSCH CE may be too high for the processor, and thus the PUSCH CE may not be completed in real time. Thus, the hybrid frequency-delay domain technique in accordance of the present disclosure may ensure that the PUSCH CE may be performed real time without incurring high computation costs even if the RB size exceeds a threshold.

The example hybrid frequency and delay domain technique for PUSCH AI CE of FIG. 13 may begin at operation 1302. At operation 1302, the noisy channel image may be utilized as the input to the PUSCH CE processing.

At operation 1304, if the number of RB in the input image is larger than a threshold N, then the delay domain denoising technique may be utilized starting at operation 1305. Otherwise, the frequency domain denoising technique may be utilized starting at operation 1312 to obtain a denoised frequency domain signal 1311. Example values of N may be 16, 20, 24, 30, or 32.

At operation 1305, input frequency domain signal may be converted to a delay domain signal using IFFT. The delay domain signal may then be centered using IFFTshift.

At operation 1306, only F percent of the delay domain signal from the center may be retained and the rest of the signal may be discarded. Example values of F may be 60%, 50% or 33%. To ensure that the remaining signals include an integer number of RBs, the number of subcarriers to be discarded can be determined as follows:

$${sc}_{cut} = floor ( floor ( \frac{{sc}_{all}}{{N}_{sc}} ) * F ) * {N}_{sc}$$

Here, sc_{cut} is the number of subcarriers to be discarded. scₐₗₗ is the total number of subcarriers in the channel image. N_{sc} is the number of subcarriers per RB (typical values are 12 and 6 for PUSCH). F is a percentage number, which represents the percentage of signals to be retained from the center.

At operation 1307, Hann window may be applied on the retained delay domain signal to suppress the spectrum leakage at the edge. The Hann window function can be written as:

$$w [ n ] = {sin}^{2} ( \frac{π n}{N} ) 0 \leq n \leq N$$

At operation 1308, the AI model (e.g., a delay domain trained ResnetU-based CE model) may be applied to filter the noise of the delay domain signal.

At operation 1309, zeros may be padded to both sides of the filtered delay domain signal to recover the delay signal to its original length.

At operation 1310, FFTshift and FFT may be applied to the denoised delay domain signal to convert back to a frequency domain signal 1311.

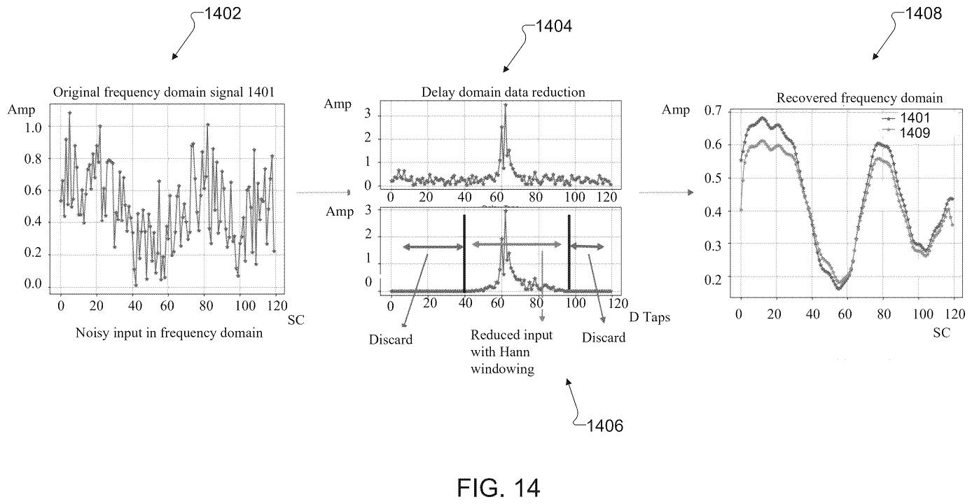

FIG. 14 illustrates example graphs depicting the hybrid frequency-delay domain CE technique of FIG. 13 in accordance with example embodiments of the present disclosure. The example graphs shown in FIG. 14 are for illustration only, and may differ as appropriate without departing from the scope of the present disclosure.

Graph 1402 shows the original frequency domain signal 1401 when a noisy channel image is input to the AI model.

Graph 1404 shows the noisy channel image input which has been converted from the frequency domain to the delay domain. Graph 1406 shows reduced noisy channel image input after the application of Hann window and discarding subcarriers. In FIG. 14, approximately 50% of delay domain signal may be retained. The AI model may then denoise the reduced delay domain signal.

Graph 1408 shows the recovered frequency domain signal 1409 after converting the denoised delay domain signal back to the frequency domain. As can be seen in Graph 1408, the recovered frequency domain signal 1409 may closely align with the original input signal 1401.

It has been shown that, for example, by only processing 50% of the signal in delay domain, the frequency domain signal very close to the original signal can be recovered.

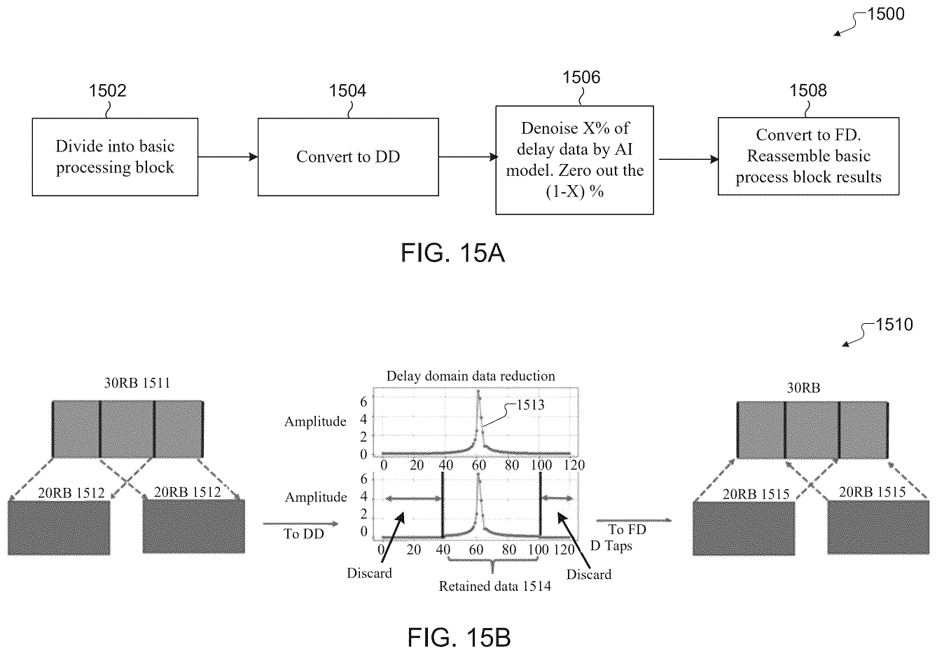

FIGS. 15A and 15B illustrate an example process 1500 of a delay domain CE technique using a fixed sized RB and an example performance 1510 thereof in accordance example embodiments of the present disclosure. The example process and performance shown in FIGS. 15A and 15B are for illustration only, and the processes could have the same or similar configuration. One or more of the components illustrated in FIGS. 15A and 15B may be implemented in specialized circuitry configured to perform the noted functions or one or more of the components may be implemented by one or more processors (e.g., the processor 225 or 415 in FIG. 2 or 4) executing instructions to perform the noted functions. Other embodiments of the delay domain CE technique in accordance with the present disclosure could be used without departing from the scope of this disclosure. FIGS. 15A and 15B do not limit the scope of this disclosure to any particular embodiment of delay domain CE techniques.

For PUSCH CE, the number of RB can dynamically change for each transmission. Thus, a trained AI model may need to be capable of working in different RB cases. This may be especially challenging for delay domain CE, as the delay domain signal for different RB sizes may have different resolution and characteristics. Further, it may be difficult to train one AI model that can perform well across different RBs in the delay domain. The present disclosure, in response, provides for training the AI model on a fixed RB number X_{RB}, and using X_{RB} as a basic building block for the whole PUSCH AI CE tasks. For each new RB case, the channel image can be divided into several basic building blocks. Each basic building block may contain X_{RB} number of RBs. For example, a basic building block can have 20 RB (X_{RB}=20), and an AI model may be trained on the 20RB delay domain data with only 50% of delay domain data retained. Each new RB case can be divided into multiple 20RB basic building blocks as shown in FIGS. 15A and 15B.

The example process 1500 of FIG. 15A may begin at operation 1502. At operation 1502, RBs in an input image may be divided into multiple basic processing or building blocks. At operation 1504, the basic processing blocks may be converted into the delay domain. At operation 1506, the AI model may denoise a portion (e.g., X %) of the delay domain signal while zeroing out the remaining portion (1-X %). At operation 1508, the denoised basic RB processing blocks may be converted back to the frequency domain and reassembled into the original RB size.

The example process 1500 may be performed, for example, as shown in FIG. 15B. In the example shown in FIG. 15B, a noisy channel image input may include a 30RB block 1511. The 30RB block 1511 may be divided into two 20RB blocks 1512 with 10 overlapped RBs in the frequency domain. The two 20RB blocks 1512 may be converted to the delay domain to generate a delay domain signal 1513. The delay domain data may be reduced by applying Hann window to a portion of the delay domain signal while discarding delay taps from the remaining portion. A trained delay domain AI model may be applied to filter the noise from the retained data (20RB blocks) 1514. The filtered 20RB blocks 1515 may be then converted back to the frequency domain and reassembled to be a 30RB block.

By utilizing the delay domain CE technique as described above, the AI model (e.g., the ResnetU-based CE model) may reduce overall computation complexity significantly.

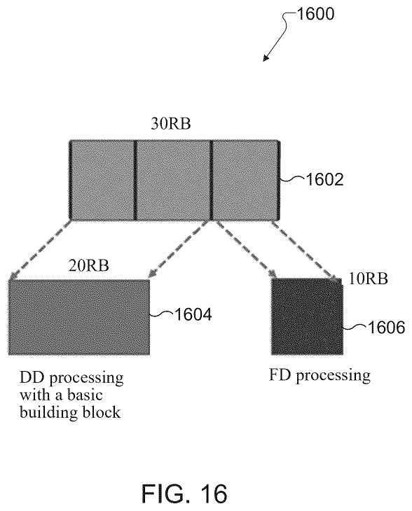

FIG. 16 illustrates an example hybrid frequency-delay domain CE technique 1600 in accordance with example embodiments of the present disclosure. The example technique shown in FIG. 16 is for illustration only, and the technique could have the same or similar configuration. One or more of the components illustrated in FIG. 16 may be implemented in specialized circuitry configured to perform the noted functions or one or more of the components may be implemented by one or more processors (e.g., the processor 225 or 415 in FIG. 2 or 4) executing instructions to perform the noted functions. Other embodiments of the hybrid frequency-delay domain CE technique in accordance with the present disclosure could be used without departing from the scope of this disclosure. FIG. 16 does not limit the scope of this disclosure to any particular embodiment of hybrid frequency-delay domain CE techniques.

In some embodiments, the total number of RBs in a noisy channel image input may not be a multiple of the number of RBs in the basic building block. In such cases, the total number of RB may be divided into two parts. One part may include the most number of RBs that are a multiple of the basic building block. These RBs may be processed by the delay domain solution with the basic building block. Another part may include the RBs that are a fraction of the basic building block. Those RBs may be processed with the frequency domain technique.

As shown in FIG. 16, the basic delay domain building block may be a 20RB block and the AI model trained on a 20RB basic processing block in the delay domain. The 30RB channel image 1602 may be divided into one or more 20RB parts 1604, which may then be processed by the delay domain trained AI model. The remaining 10RB part 1606 may be processed by a frequency domain AI model.

For example, assume that the noisy channel image input is a 50RB input image. In this example, the 50RB may be divided into two 20RB blocks and one 10RB block. The two 20RB blocks may be processed by the delay domain basic building block trained AI model, and the one 10RB block may be processed by the frequency domain AI model.

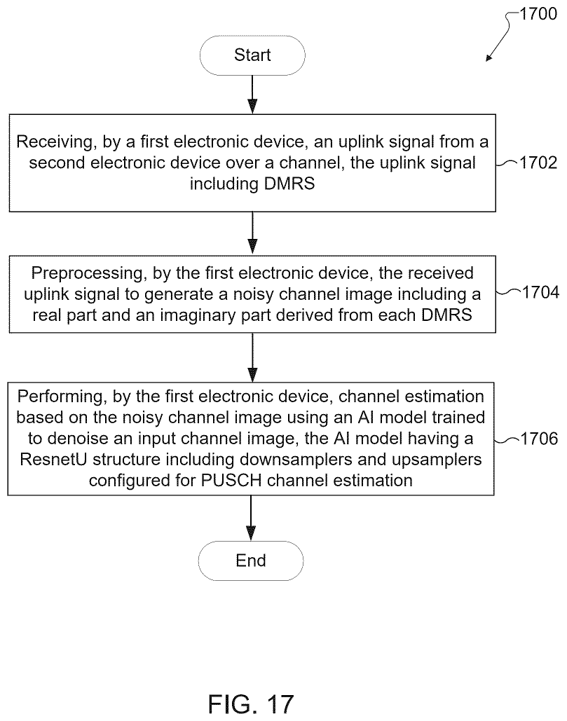

FIG. 17 illustrates a flow chart for a ResnetU-based CE method 1700 according to embodiments of the present disclosure. The embodiment of the ResnetU-based CE method in FIG. 17 is for illustration only. Other embodiments of a ResnetU-based CE method may be used without departing from the scope of this disclosure. In the example of FIG. 17, the ResnetU-based CE method 1700 may be performed by a first electronic device (such as a base station 101-103 of FIGS. 1 and 2).

In the example of FIG. 17, the method 1700 begins at step 1702. At step 1702, the first electronic device may receive an uplink signal from a second electronic device over a channel. The second electronic may be, e.g., a UE 111-116 of FIGS. 1 and 3. The uplink signal may include DMRS.

At step 1704, the first electronic device may preprocess the received uplink signal to generate a noisy channel image including a real part and an imaginary part derived from each DMRS.

At step 1706, the first electronic device may perform channel estimation based on the noisy channel image using an AI model trained to denoise an input channel image, the AI model having a ResnetU structure including downsamplers and upsamplers configured for PUSCH channel estimation. This may include the first electronics to determine downsampling factors of the downsamplers such that a product of the downsampling factors matches a total number of subcarriers per resource block in PUSCH and padding is not added at a bottom layer of the ResnetU, compute a kernel size and a padding size such that a size of the noisy channel image is reduced by the downsampling factors; downsample, using the downsamplers, the noisy channel image based on the downsampling factors, the kernel size and padding, and upsample, using the upsamplers, a batch image from the bottom layer based on a nonuniform pixelshuffling, the batch image derived from the downsampled noisy channel image processed at the bottom layer. The first electronic device may upsample the batch image by reshaping the batch image based on nonuniform upsampling factors for antenna and subcarrier dimensions, reorganizing the reshaped batch image such that pixels from different channels are interleaved, and reshaping the reorganized batch image based on the nonuniform upsampling factors.

In one embodiment, the AI model may be trained by receiving a first DMRS symbol and a second DMRS symbol, obtaining an initial channel estimate of an input channel image using an optimization technique, flipping the first DMRS symbol in a subcarrier dimension and concatenating the flipped first DMRS symbol to edges of the second DMRS symbol, padding the second DMRS symbol with the flipped first DMRS symbol along the subcarrier dimension, flipping the second DMRS symbol in the subcarrier dimension and concatenating the second DMRS symbol to edges of the first DMRS symbol, padding the first DMRS symbol with the flipped second DMRS symbol along the subcarrier dimension, denoising the input channel image using the AI model, and removing padded flipped first and second DMRS symbols.

In one embodiment, the first electronic device may also determine whether a number of RBs associated with the noisy channel image is greater than a threshold. Based on a determination that the number of the RBs is greater than the threshold, the first electronic device may convert the noisy channel image from frequency domain to delay domain to generate a delay domain signal and shifting the delay domain signal to a center, select a portion of the delay domain signal from the center and discarding a rest of the delay domain signal, apply a window to the selected portion of the delay domain signal, denoise the selected portion of the delay domain signal using the AI model, pad zeros to the denoised delay domain signal to an initial length of the delay domain signal, and convert the denoised delay domain signal into the frequency domain to generate a denoised frequency domain signal.

In one embodiment, the first electronic device may also determine whether a number of RBs associated with the noisy channel image is greater than a threshold. Based on a determination that the number of the RBs is not greater than the threshold, the first electronic device may denoise the noisy channel image in frequency domain using the AI model.

In one embodiment, the AI model may be trained based on a building block having a fixed number of RBs associated with an input channel image. The first electronic device may perform channel estimation by determining whether a total number of RBs associated with the noisy channel image is greater than the fixed number of the RBs of the building block, in response to determining that the total number of RBs is greater than the fixed number, segmenting the RBs associated with the noisy channel image into a plurality of segmented blocks of RBs using the building block (each segmented block having the fixed number of RBs), converting the segmented blocks into delay domain to generate a delay domain data, denoising a portion of the delay domain data and discarding remaining portion of the delay domain data, and converting the denoised delay domain data into frequency domain to generate a denoised frequency domain data and reassembling the denoised frequency domain data into the total number of RBs.

In one embodiment, the AI model may be trained based on a building block having a fixed number of RBs associated with an input channel image. The first electronic device may perform channel estimation by determining whether a total number of RBs associated with the noisy channel image is greater than the fixed number of the RBs of the building block, in response to determining that the total number of RBs is greater than the fixed number and is not a multiple of the fixed number, segmenting the RBs associated with the noisy channel image into a first segmented block of RBs and a second segmented block of RBs, the first segmented block having the fixed number of RBs and the second segmented block having a less number of RBs than the fixed number, converting the first segmented block into delay domain and denoising the first segmented block in the delay domain, and denoising the second segmented block in frequency domain.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method for channel estimation, the method comprising:
receiving, by a first electronic device, an uplink signal from a second electronic device over a channel, the uplink signal including demodulation references signals (DMRS);
preprocessing, by the first electronic device, the received uplink signal to generate a noisy channel image including a real part and an imaginary part derived from each DMRS; and
performing, by the first electronic device, channel estimation based on the noisy channel image using an artificial intelligence (AI) model trained to denoise an input channel image, the AI model having a residual network U-shaped (ResnetU) structure including downsamplers and upsamplers configured for physical uplink shared channel (PUSCH) channel estimation.

2. The method of claim 1, wherein performing channel estimation comprises:
determining downsampling factors of the downsamplers such that a product of the downsampling factors matches a total number of subcarriers per resource block in PUSCH and padding is not added at a bottom layer of the ResnetU;
computing a kernel size and a padding size such that a size of the noisy channel image is reduced by the downsampling factors;
downsampling, using the downsamplers, the noisy channel image based on the downsampling factors, the kernel size and padding; and
upsampling, using the upsamplers, a batch image from the bottom layer based on a nonuniform pixelshuffling, the batch image derived from the downsampled noisy channel image processed at the bottom layer, wherein upsampling the batch image comprises:
reshaping the batch image based on nonuniform upsampling factors for antenna and subcarrier dimensions;
reorganizing the reshaped batch image such that pixels from different channels are interleaved; and
reshaping the reorganized batch image based on the nonuniform upsampling factors.

3. The method of claim 1, wherein the AI model is trained by:
receiving a first DMRS symbol and a second DMRS symbol;
obtaining an initial channel estimate of an input channel image using an optimization technique;
flipping the first DMRS symbol in a subcarrier dimension and concatenating the flipped first DMRS symbol to edges of the second DMRS symbol;
padding the second DMRS symbol with the flipped first DMRS symbol along the subcarrier dimension;
flipping the second DMRS symbol in the subcarrier dimension and concatenating the second DMRS symbol to edges of the first DMRS symbol;
padding the first DMRS symbol with the flipped second DMRS symbol along the subcarrier dimension;
denoising the input channel image using the AI model; and
removing padded flipped first and second DMRS symbols.

4. The method of claim 1, further comprising:
determining whether a number of resource blocks (RBs) associated with the noisy channel image is greater than a threshold;
based on a determination that the number of the RBs is greater than the threshold, converting the noisy channel image from frequency domain to delay domain to generate a delay domain signal and shifting the delay domain signal to a center;
selecting a portion of the delay domain signal from the center and discarding a rest of the delay domain signal;
applying a window to the selected portion of the delay domain signal;
denoising the selected portion of the delay domain signal using the AI model;
padding zeros to the denoised delay domain signal to an initial length of the delay domain signal; and
converting the denoised delay domain signal into the frequency domain to generate a denoised frequency domain signal.

5. The method of claim 1, further comprising:
determining whether a number of resource blocks (RBs) associated with the noisy channel image is greater than a threshold; and
based on a determination that the number of the RBs is not greater than the threshold, denoising the noisy channel image in frequency domain using the AI model.

6. The method of claim 1, wherein:
the AI model is trained based on a building block having a fixed number of resource blocks (RBs) associated with an input channel image; and
performing channel estimation comprises:
determining whether a total number of RBs associated with the noisy channel image is greater than the fixed number of the RBs of the building block;
in response to determining that the total number of RBs is greater than the fixed number, segmenting the RBs associated with the noisy channel image into a plurality of segmented blocks of RBs using the building block, each segmented block having the fixed number of RBs;
converting the segmented blocks into delay domain to generate a delay domain data;
denoising a portion of the delay domain data and discarding remaining portion of the delay domain data; and
converting the denoised delay domain data into frequency domain to generate a denoised frequency domain data and reassembling the denoised frequency domain data into the total number of RBs.

7. The method of claim 1, wherein:
the AI model is trained based on a building block having a fixed number of resource blocks (RBs) associated with an input channel image; and
performing channel estimation comprises:
determining whether a total number of RBs associated with the noisy channel image is greater than the fixed number of the RBs of the building block;
in response to determining that the total number of RBs is greater than the fixed number and is not a multiple of the fixed number, segmenting the RBs associated with the noisy channel image into a first segmented block of RBs and a second segmented block of RBs, the first segmented block having the fixed number of RBs and the second segmented block having a less number of RBs than the fixed number;
converting the first segmented block into delay domain and denoising the first segmented block in the delay domain; and
denoising the second segmented block in frequency domain.

8. A first electronic device comprising:
memory; and
a processor operably coupled to the memory, the processor configured to:
receive an uplink signal from a second electronic device over a channel, the uplink signal including demodulation references signals (DMRS);
preprocess the received uplink signal to generate a noisy channel image including a real part and an imaginary part derived from each DMRS; and
perform channel estimation based on the noisy channel image using an artificial intelligence (AI) model trained to denoise an input channel image, the AI model having a residual network U-shaped (ResnetU) structure including downsamplers and upsamplers configured for physical uplink shared channel (PUSCH) channel estimation.

9. The first electronics device of claim 8, wherein to perform channel estimation the processor is further configured to:
determine downsampling factors of the downsamplers such that a product of the downsampling factors matches a total number of subcarriers per resource block in PUSCH and padding is not added at a bottom layer of the ResnetU;
compute a kernel size and a padding size such that a size of the noisy channel image is reduced by the downsampling factors;
downsample, using the downsamplers, the noisy channel image based on the downsampling factors, the kernel size and padding; and
upsample, using the upsamplers, a batch image from the bottom layer based on a nonuniform pixelshuffling, the batch image derived from the downsampled noisy channel image processed at the bottom layer, wherein upsampling the batch image comprises:
reshape the batch image based on nonuniform upsampling factors for antenna and subcarrier dimensions;
reorganize the reshaped batch image such that pixels from different channels are interleaved; and
reshape the reorganized batch image based on the nonuniform upsampling factors.

10. The first electronics device of claim 8, wherein the AI model is trained by:
receiving a first DMRS symbol and a second DMRS symbol;
obtaining an initial channel estimate of an input channel image using an optimization technique;
flipping the first DMRS symbol in a subcarrier dimension and concatenating the flipped first DMRS symbol to edges of the second DMRS symbol;
padding the second DMRS symbol with the flipped first DMRS symbol along the subcarrier dimension;
flipping the second DMRS symbol in the subcarrier dimension and concatenating the second DMRS symbol to edges of the first DMRS symbol;
padding the first DMRS symbol with the flipped second DMRS symbol along the subcarrier dimension;
denoising the input channel image using the AI model; and
removing padded flipped first and second DMRS symbols.

11. The first electronics device of claim 8, wherein the processor is further configured to:
determine whether a number of resource blocks (RBs) associated with the noisy channel image is greater than a threshold;
based on a determination that the number of the RBs is greater than the threshold, convert the noisy channel image from frequency domain to delay domain to generate a delay domain signal and shift the delay domain signal to a center;
select a portion of the delay domain signal from the center and discarding a rest of the delay domain signal;
apply a window to the selected portion of the delay domain signal;
denoise the selected portion of the delay domain signal using the AI model;
pad zeros to the denoised delay domain signal to an initial length of the delay domain signal; and
convert the denoised delay domain signal into the frequency domain to generate a denoised frequency domain signal.

12. The first electronics device of claim 8, wherein the processor is further configured to:
determine whether a number of resource blocks (RBs) associated with the noisy channel image is greater than a threshold; and
based on a determination that the number of the RBs is not greater than the threshold, denoise the noisy channel image in frequency domain using the AI model.

13. The first electronics device of claim 8, wherein:
the AI model is trained based on a building block having a fixed number of resource blocks (RBs) associated with an input channel image; and
to perform channel estimation, the processor is configured to:
determine whether a total number of RBs associated with the noisy channel image is greater than the fixed number of the RBs of the building block;
in response to determining that the total number of RBs is greater than the fixed number, segment the RBs associated with the noisy channel image into a plurality of segmented blocks of RBs using the building block, each segmented block having the fixed number of RBs;
convert the segmented blocks into delay domain to generate a delay domain data;
denoise a portion of the delay domain data and discard remaining portion of the delay domain data; and
convert the denoised delay domain data into frequency domain to generate a denoised frequency domain data and reassembling the denoised frequency domain data into the total number of RBs.

14. The first electronics device of claim 8, wherein:
the AI model is trained based on a building block having a fixed number of resource blocks (RBs) associated with an input channel image; and
to perform channel estimation, the processor is further configured to:
determine whether a total number of RBs associated with the noisy channel image is greater than the fixed number of the RBs of the building block;
in response to determining that the total number of RBs is greater than the fixed number and is not a multiple of the fixed number, segment the RBs associated with the noisy channel image into a first segmented block of RBs and a second segmented block of RBs, the first segmented block having the fixed number of RBs and the second segmented block having a less number of RBs than the fixed number;
convert the first segmented block into delay domain and denoising the first segmented block in the delay domain; and
denoise the second segmented block in frequency domain.

15. A non-transitory computer readable medium embodying a computer program, the computer program comprising program code that, when executed by a processor of a first electronic device, causes the first electronic device to:
receive an uplink signal from a second electronic device over a channel, the uplink signal including demodulation references signals (DMRS);
preprocess the received uplink signal to generate a noisy channel image including a real part and an imaginary part derived from each DMRS; and
perform channel estimation based on the noisy channel image using an artificial intelligence (AI) model trained to denoise an input channel image, the AI model having a residual network U-shaped (ResnetU) structure including downsamplers and upsamplers configured for physical uplink shared channel (PUSCH) channel estimation.

16. The non-transitory computer readable medium of claim 15, wherein the program code that, when executed by the processor of the first electronic device, causes the first electronic device to perform the channel estimation comprises program code that, when executed by the processor of the first electronic device, causes the first electronic device to:
determine downsampling factors of the downsamplers such that a product of the downsampling factors matches a total number of subcarriers per resource block in PUSCH and padding is not added at a bottom layer of the ResnetU;
compute a kernel size and a padding size such that a size of the noisy channel image is reduced by the downsampling factors;
downsample, using the downsamplers, the noisy channel image based on the downsampling factors, the kernel size and padding; and
upsample, using the upsamplers, a batch image from the bottom layer based on a nonuniform pixelshuffling, the batch image derived from the downsampled noisy channel image processed at the bottom layer, wherein upsampling the batch image comprises:
reshape the batch image based on nonuniform upsampling factors for antenna and subcarrier dimensions;
reorganize the reshaped batch image such that pixels from different channels are interleaved; and
reshape the reorganized batch image based on the nonuniform upsampling factors.

17. The non-transitory computer readable medium of claim 15, wherein the AI model is trained by:
receiving a first DMRS symbol and a second DMRS symbol;
obtaining an initial channel estimate of an input channel image using an optimization technique;
flipping the first DMRS symbol in a subcarrier dimension and concatenating the flipped first DMRS symbol to edges of the second DMRS symbol;
padding the second DMRS symbol with the flipped first DMRS symbol along the subcarrier dimension;
flipping the second DMRS symbol in the subcarrier dimension and concatenating the second DMRS symbol to edges of the first DMRS symbol;
padding the first DMRS symbol with the flipped second DMRS symbol along the subcarrier dimension;
denoising the input channel image using the AI model; and
removing padded flipped first and second DMRS symbols.

18. The non-transitory computer readable medium of claim 15, further comprising program code that, when executed by a processor of a first electronic device, causes the first electronic device to:
determine whether a number of resource blocks (RBs) associated with the noisy channel image is greater than a threshold;
based on a determination that the number of the RBs is greater than the threshold, convert the noisy channel image from frequency domain to delay domain to generate a delay domain signal and shift the delay domain signal to a center;
select a portion of the delay domain signal from the center and discarding a rest of the delay domain signal;
apply a window to the selected portion of the delay domain signal;
denoise the selected portion of the delay domain signal using the AI model;
pad zeros to the denoised delay domain signal to an initial length of the delay domain signal; and
convert the denoised delay domain signal into the frequency domain to generate a denoised frequency domain signal.

19. The non-transitory computer readable medium of claim 15, further comprising program code that, when executed by a processor of a first electronic device, causes the first electronic device to:
determine whether a number of resource blocks (RBs) associated with the noisy channel image is greater than a threshold; and
based on a determination that the number of the RBs is not greater than the threshold, denoise the noisy channel image in frequency domain using the AI model.

20. The non-transitory computer readable medium of claim 15, wherein:
the AI model is trained based on a building block having a fixed number of resource blocks (RBs) associated with an input channel image; and
to perform channel estimation, the processor is configured to:
determine whether a total number of RBs associated with the noisy channel image is greater than the fixed number of the RBs of the building block;
in response to determining that the total number of RBs is greater than the fixed number, segment the RBs associated with the noisy channel image into a plurality of segmented blocks of RBs using the building block, each segmented block having the fixed number of RBs;
convert the segmented blocks into delay domain to generate a delay domain data;
denoise a portion of the delay domain data and discard remaining portion of the delay domain data; and
convert the denoised delay domain data into frequency domain to generate a denoised frequency domain data and reassembling the denoised frequency domain data into the total number of RBs.
